(19) United States
(12) Patent Application Publication
(10) Pub. No.: US 2006/0291804 A1
(43) Pub. Date: Dec. 28, 2006

(54) Recording device, program and integrated circuit

(76) Inventors: Ryuichi Hori, Hiroshima-shi (JP); Youichi Yamamoto, Hiroshima-shi (JP); Shuji Okamoto, Kure-shi (JP); Yasuyuki Matuura, Higashihiroshima-shi (JP); Masahiro Kawasaki, Hiroshima-shi (JP); Akihiro Watanabe, Higashihiroshima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/546,678

(22) PCT Filed: Jun. 11, 2004
(86) PCT No.: PCT/JP04/08555

§ 371 Date: Aug. 23, 2005

(30) Foreign Application Priority Data
Jun. 11, 2003 (JP) 2003-167056

(51) Int. Cl. H04N 7/00

(52) U.S. Cl. 386/95

(57) ABSTRACT

When receiving a record presetting from the record presetting unit 8, the detection unit 10 compares the received record presetting with a record presetting that has been received earlier, to detect, if time periods indicated by the record presettings overlap, an overlapping time portion and one or more non-overlapping time portion. The detection unit 10 then newly generates record presettings in one-to-one correspondence with the overlapping and non-overlapping time portions. The recording unit 11 performs a recording operation with reference to the record presettings newly generated by the detection unit 10. Thus, the recording unit 11 can perform a recording operation as described by the original record presettings, which indicate the time periods that overlap. The generation unit 12 generates, on a storage medium, Cell information for each of the original record presettings, and appends user information to the Cell information.

### TECHNICAL FIELD

The present invention relates to a recording device, a program, and an integrated circuit to write video data into a storage medium. The present invention particularly relates to a technique to realize multiuser management on the recording device.

### BACKGROUND ART

In recent years, recording devices including large-capacity storage media have been introduced to the market. This tends to increase the number of cases where multiple users share one recording device.

When multiple users share one recording device, a problem that one user mistakenly deletes or edits video data recorded by another user frequently occurs.

To solve the problem, multiuser management currently used in operating systems such as UNIX (registered trademark) and Windows (registered trademark) may be applied to the recording device, in order to limit individual users' access to each set of video data.

In this way, each set of video data can be edited or deleted only by users who has have access rights. This can prevent the above-mentioned mistaken deletion and edition of video data.

It is desirable to introduce the multiuser management in order to prevent mistaken operations mentioned above. However, the multiuser management is not suitable for some functions of the recording device.

Such functions include a record presetting function. Here, it is assumed that time periods indicated by two record presettings for the same channel made by users A and B overlap each other. In the case of a conventional recording device in which the multiuser management is applied, the record presetting made earlier by the user A is accepted, but the record presetting made later by the user B is rejected.

If the recording device is used by only one user, time periods indicated by a plurality of record presettings for the same channel overlap each other, only by mistake. However, when the recording device is shared by multiple users, lack of communications among the users tends to frequently cause a problem that time periods indicated by a plurality of record presettings for the same channel overlap each other.

Here, even when the time periods indicated by the record presettings for the same channel made by the users A and B overlap each other and the record presetting made later by the user B is rejected, the user A may kindly let the user B watch recorded video data. If such is the case, there is no problem. However, this relies on good will of the user A. The user A may not necessarily let the user B watch the obtained video data, and refuse to do so for the sake of privacy.

As described above, only the user A who happens to make the record presetting earlier than the user B exclusively obtains video data and has a right to delete the video data, in the case of the conventional recording device in which the multiuser management is applied. This is unacceptable for the user B whose record presetting is rejected.

### DISCLOSURE OF THE INVENTION

It is a first object of the present invention to provide a recording device with multiuser management which, when time periods indicated by record presettings for the same channel made by multiple users overlap each other, enables all of the record presettings to be executed.

The object can be achieved by a recording device that performs a recording operation based on a plurality of record presettings made by a plurality of users. The recording device including: a detection unit operable to, if time periods indicated by the plurality of record presettings have an overlapping time portion, detect the overlapping time portion and a non-overlapping time portion; a writing unit operable to write video data for the overlapping time portion and video data for the non-overlapping time portion, onto a storage medium; and a generation unit operable to generate, on the storage medium, period information that expresses each of the time periods indicated by the plurality of record presettings. The period information specifies video data for one or more time portions which form the corresponding time period.

A recording operation for each of the overlapping time portion and the non-overlapping time portion is separately performed, executing recording for all of the record presettings even when the time periods indicated by the record presettings for the same channel overlap each other.

Once the video data corresponding to each of the overlapping time portion and the non-overlapping time portion is stored in the storage medium, the generation unit generates the period information that specifies each of the time periods indicated by the record presettings.

The period information corresponds to each of the users. This enables each of the users to exclusively control corresponding period information. Accordingly, a right to play back and delete video data is given to each of the pieces of period information.

The video data for each of the overlapping and non-overlapping time portions is not owned by the individual users. In this way, the video data can not be deleted by any of the users without the other users' consent. This prevents a trouble among the users.

Here, the recording device may further include: an authentication unit operable to, when a user requests a deletion or edition operation on the period information for the record presetting of the closed mode, receive user information unique to the user who requests the deletion or edition operation, and authenticate the user by comparing the received user information with the user information appended to the period information; and an execution unit operable to execute the deletion or edition operation only when the authentication unit successfully authenticates the user.

According to this construction, when the user requests playback, deletion, and edition operations of recorded content, the authentication unit authenticates the user to judge whether the user has an access right to the recorded content. This prevents an illegal conduct of, without obtaining permission, playing back, deleting, or editing the recorded content which the user does not have recorded. As a result, a privacy of a user who has the recorded content recorded is more highly secured.

Here, the writing unit may write, onto the storage medium, a reference counter for the video data for the overlapping time portion. The reference counter shows a number of pieces of period information that reference the video data.

Here, the recording device may further include a deletion unit operable to delete the video data for the overlapping time portion only when the reference counter indicates zero. The reference counter is decremented by one, every time a piece of period information referencing the video data for the overlapping time portion is deleted.

According to this construction, even when one of the users who have the video data corresponding to the overlapping time portion recorded watches and then attempts to delete the video data, the video data is not deleted unless the reference counter indicates zero. In this way, the other users can still watch the video data corresponding to the overlapping time portion.

Here, the recording device may further include a display unit operable to display a provisional available capacity of the storage medium. The provisional available capacity is calculated by subtracting a predetermined value from a maximum capacity of the storage medium. The predetermined value is determined in accordance with a number of pieces of period information that reference the video data for each of the overlapping and non-overlapping time portions.

According to this construction, the users who have the video data corresponding to the overlapping time portion recorded each realize that the video data is also recorded by the other users. This encourages the users to save the capacity of the storage medium by performing data reduction voluntarily and avoiding unnecessary recording operations.

### BRIEF DESCRIPTION OF THE DRAWINGS

FIG. 1 illustrates a logical format of a storage medium.

FIG. 2 illustrates recorded content with VOBs, reference counters, and Cell information.

FIG. 3 illustrates an inner structure of a recording device.

FIG. 4 illustrates a functional structure of a program stored in a ROM 9 (shown in FIG. 3).

FIG. 5 illustrates an example of a record presetting menu.

FIG. 6 illustrates an example of record presetting information stored in a ROM 9 (shown in FIG. 3).

FIG. 7 illustrates how user information is appended to Cell information.

FIG. 8 is a flowchart to detect an overlapping time portion among time periods indicated by record presettings made by multiple users, and to generate record presettings for each of the overlapping time portion and non-overlapping time portions.

FIG. 9A illustrates, as an example, that recording start date and time indicated by a record presetting i is earlier than recording end date and time indicated by a record presetting j in the process of detecting an overlapping time portion, FIG. 9B illustrates, as an example, that recording end date and time indicated by the record presetting i is later than recording start date and time indicated by the record presetting j in the process of detecting the overlapping time portion, and FIG. 9C illustrates, as an example, how to detect start date and time and end date and time of the overlapping time portion.

FIG. 10 is a flow chart illustrating an operation to delete video data.

FIG. 11 illustrates, as an example, record presettings made by three users.

FIG. 12 illustrates details of the record presettings made by the three users shown in FIG. 11.

FIG. 13 illustrates record presetting information which is stored in the RAM 7 after generated in such a manner that a detection unit 10 (shown in FIG. 4) detects an overlapping time portion and generate record presetting for each of the overlapping time portion and non-overlapping time portions, based on the details of the record presettings shown in FIG. 11.

FIG. 14 illustrates, using VOBs, reference counters, and Cell information, a result of recording performed based on the record presetting information shown in FIG. 13.

FIG. 15 illustrates a recorded content menu which lists a plurality of pieces of recorded content obtained as a result of recording operations for an overlapping time portion and non-overlapping time portions.

FIG. 16 illustrates a structure of management information to realize a deleting operation relating to a second embodiment of the present invention.

FIG. 17 is a flow chart to illustrate the deleting operation relating to the second embodiment.

### BEST MODE FOR CARRYING OUT THE INVENTION

### First Embodiment

The following describes a recording device relating to a first embodiment of the present invention.

(Data Construction)

The following part describes a logical format used in the recording device relating to the first embodiment of the present invention to perform a recording operation.

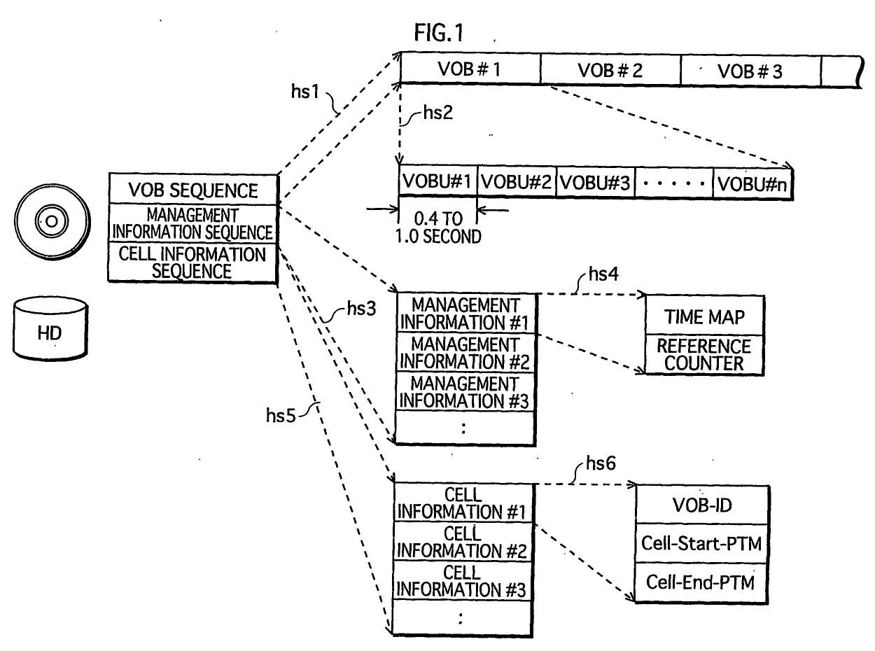

FIG. 1 illustrates the logical format. As a result of a recording operation performed by the recording device, a Video Object (VOB) sequence, a management information sequence, and a Cell information sequence are stored in a storage medium such as a hard disk (HD) or a digital versatile disk (DVD).

As shown by a dotted line hs1, a VOB sequence is made up by a plurality of VOBs (VOB#1, VOB#2, and VOB#3).

A VOB is video data, more specifically, a program stream obtained by interleaving and multiplexing a video stream and an audio stream. A video stream is made up by a plurality of sets of picture data which are compressed and encoded. Each set of picture data corresponds to data of one picture, and is displayed by displaying image signals for about 33 milliseconds. An audio stream is made up by a plurality of audio frames which are compressed and encoded.

As shown by a dotted arrow hs2, a VOB, which is obtained by interleaving and multiplexing video and audio streams, is made up by a plurality of Video Object Units (VOBUs) arranged in chronological order. A VOBU is a minimum decoding unit for a corresponding VOB. A VOBU includes a Group of Pictures (GOP) and a plurality of audio frames to be played back at the same time as the GOP. A GOP is made up by a plurality of sets of picture data and corresponds to 0.4 to 1.0 second.

The following part describes a management information sequence. As shown by a dotted arrow hs3, a management information sequence is made up by a plurality of pieces of management information (management informational, #2, and #3) which respectively correspond to the VOBs #1 to #3. Furthermore, as shown by a dotted arrow hs4, each piece of management information includes a time map and a reference counter.

A time map is a reference table to indirectly reference addresses of a plurality of start points in a corresponding VOB based on time information. The recording device employs a variable-length encoding and compressing method. Therefore, each VOBU including a GOP may have a different size and a different playback time period. However, when a time for a playback operation is designated, picture data in a VOBU corresponding to the designated time can be identified by referencing the time map.

A reference counter shows a count value indicating the number of times a corresponding VOB is indirectly referenced.

The following part describes Cell information. Cell information is period information to define logical recorded content on a VOB. Recorded content is logical in that recorded content is defined based on indirect referencing using the time map as a reference table. As shown by a dotted line hs6, Cell information includes a VOB-ID, a Cell_Start_PTM, a Cell_End_PTM, and user information (not shown in FIG. 1). A VOB-ID is an ID identifying a VOB to which an IN-point and an OUT-point of recorded content belong. A Cell_Start_PTM is a relative time from the start of the VOB to the IN-point. A Cell_End_PTM is a relative time from the start of the VOB to the OUT-point. User information identifies a user who has corresponding recorded content recorded. A VOBU has a time accuracy of 0.4 to 1.0 second. On the other hand, a Cell_Start_PTM and a Cell_End_PTM have a time accuracy of not longer than 33 milliseconds which is a display time period of one picture. Therefore, IN- and OUT-points for recorded content have a time accuracy equal to that of a set of picture data included in a VOBU.

User information is information unique to a user who has corresponding video data recorded, and used to judge whether a user who requests a playback operation of the video data is the same as the user who has the video data recorded.

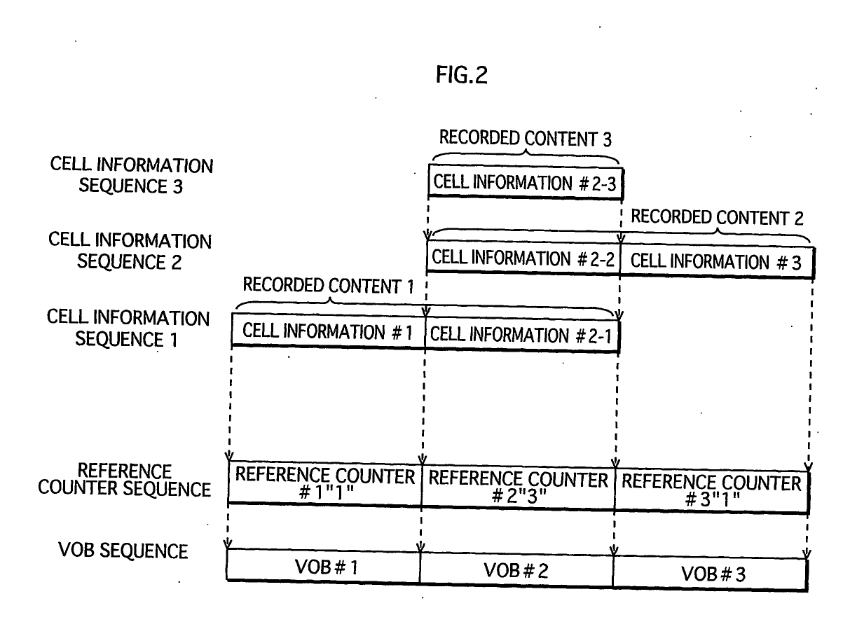

FIG. 2 illustrates how to define recorded content by the indirect referencing. In FIG. 2, three pieces of recorded content 1, 2 and 3 that overlap each other in terms of time period and channel are each defined based on the indirect referencing by Cell information. Here, the pieces of recorded content 1, 2 and 3 respectively indicate time periods indicated by three record presettings made by three users. Cell information has an advantage of being able to define the pieces of recorded content that overlap each other in terms of time period and channel after a recording operation is performed. In FIG. 2, a VOB 1 and a VOB 3 are respectively referenced by the pieces of recorded content 1 and 2. Accordingly, reference counters for the VOBs 1 and 3 each indicate one. On the other hand, the VOB 2 is referenced by the three pieces of recorded content 1, 2 and 3, that is to say, indirectly referenced three times. Accordingly, a reference counter for the VOB 2 indicates three.

(Construction)

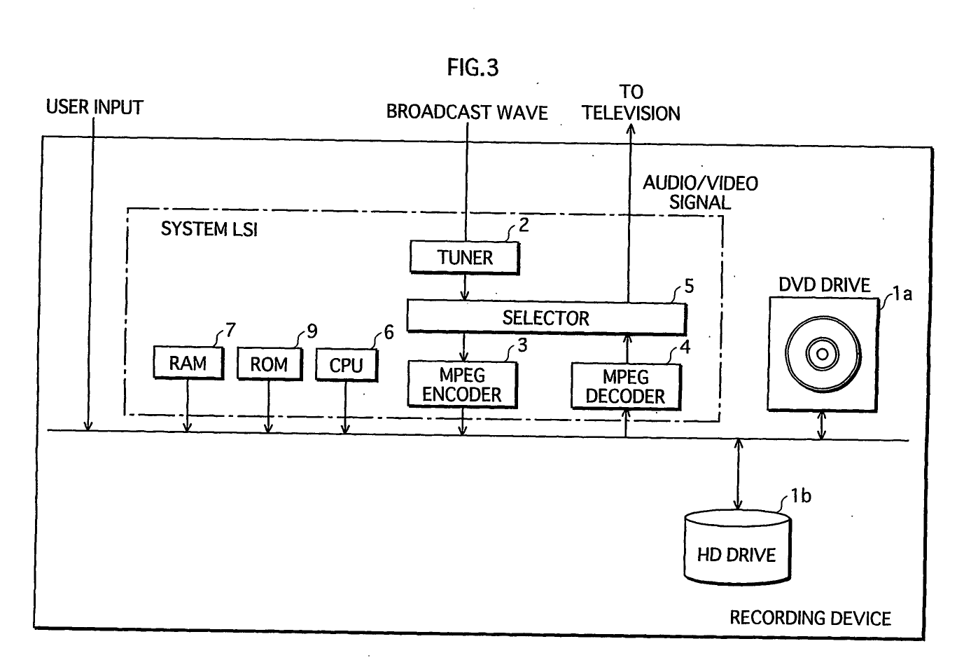

The following part describes the recording device relating to the first embodiment of the present invention. The recording device is mainly constituted by a system large scale integration (LSI) and a driving device. The recording device can be industrially manufactured by mounting the system LSI and the driving device with a cabinet and a substrate of a device. The system LSI is an integrated circuit which integrates various processing units that function as a HD recorder. The recording device, which is manufactured in the above-described manner, has an inner structure shown in FIG. 3. As shown in FIG. 3, the recording device includes a DVD drive 1a, a HD drive 1b, a tuner 2, an MPEG encoder 3, an MPEG decoder 4, a selector 5, a CPU 6, a RAM 7, and a ROM 9.

The DVD drive 1a is a device with which a DVD is loaded. Similarly to the HD drive 1b (mentioned later), the DVD drive 1a reads or deletes a VOBU in accordance with a read command or a deletion command from a user. The DVD loaded with the DVD drive 1a is a portable medium. Therefore, the DVD drive 1a is used to create backup copies of VOBs, management information and Cell information stored in the HD drive 1b.

The HD drive 1b is a fixed disk device for storing VOBs, management information, and Cell information in the logical format shown in FIG. 1. The HD drive 1b reads or deletes a VOBU in the VOBs stored in the HD, in accordance with a read command or a deletion command from the user.

The tuner 2 demodulates broadcast signals for a television, and outputs video and audio signals to the MPEG encoder 3.

The MPEG encoder 3 encodes the video and audio signals output from the tuner 2 to generate VOBUs.

The MPEG encoder 4 is a circuit to decode VOBUs read from the DVD drive 1a or the HD drive 1b.

The selector 5 is a circuit to select whether to output the broadcast waves input from the tuner 2 to the MPEG encoder 3 or to output the VOBUs generated by the MPEG decoder 4 to the television.

The CPU 6 executes a program stored in the ROM 9, to perform an integrated control on the recording device.

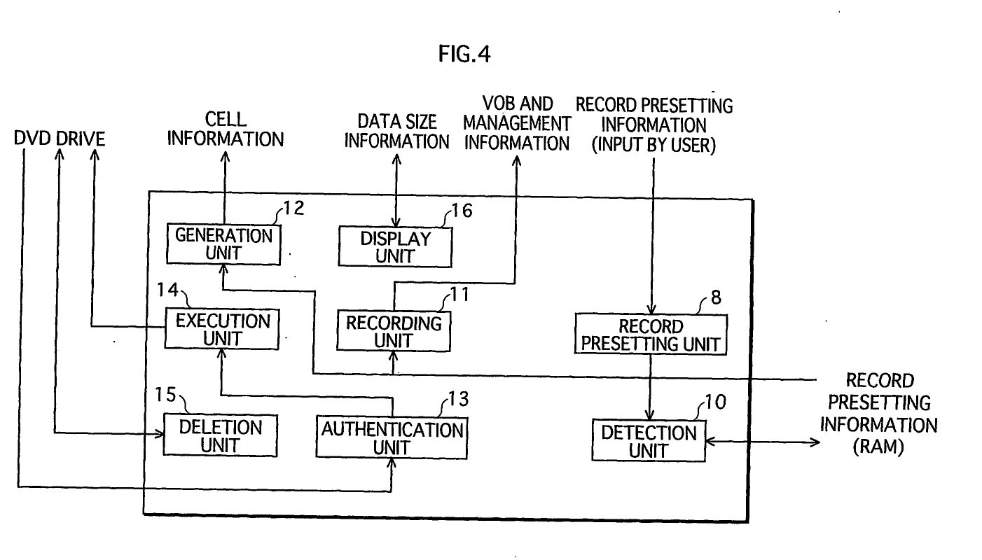

The ROM 9 stores the program relating to the multiuser management of the recording device. The program is read by the CPU 6 and executed in cooperation with hardware resources, to achieve concrete units such as a record presetting unit 8, a detection unit 10, a recording unit 11, a generation unit 12, an authentication unit 13, an execution unit 14, a deletion unit 15, and a display unit 16 shown in FIG. 4.

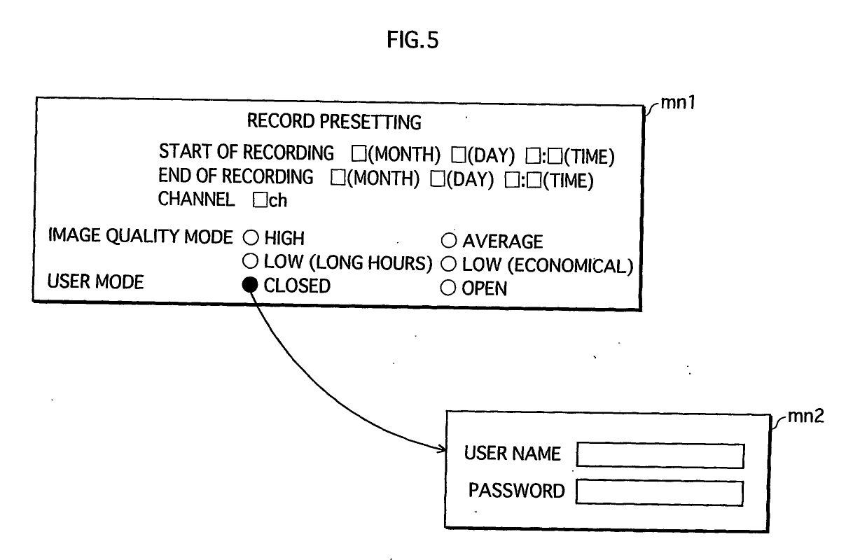

The record presetting unit 8 receives an input of a record presetting from the user through a record presetting menu such as mn1 illustrated in FIG. 5. The record presetting menu mn1 shown in FIG. 5 shows item information used in a conventional Video Cassette Recorder (VCR) and item information newly introduced in the recording device relating to the first embodiment. The former item information is made up of recording start date and time, recording end date and time, a channel, and an image quality mode. The recording start date and time and the recording end date and time specify date and time to start and end a recording operation in terms of month, day, hour and minute. The channel shows a number identifying a channel to which the recording operation is to be performed. The image quality mode is set by selecting one of four options including “high”, “normal”, “low (long hours)”, and “low (economical)”.

The latter item information is made up of a user mode, which is set by selecting one of two options including a closed mode and an open mode. When the user selects the closed mode for the record presetting, user information is appended to Cell information indicating a time period indicated by the record presetting. In this way, a playback operation based on the Cell information and deletion of the Cell information requires user authentication using the user information. On the other hand, when the user selects the open mode, anyone can access the Cell information and user authentication is not required. A user registration menu mn2 is displayed when the closed mode is selected, to register a user name and a password.

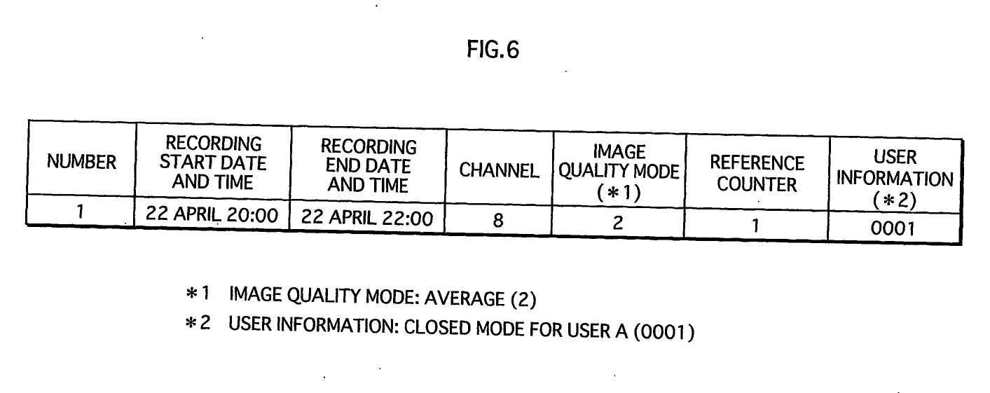

The RAM 7 receives record presetting information from the detection unit 10 (mentioned later), and stores the information therein. In FIG. 6, the record presetting information includes item information made up of a number, recording start date and time, recording end date and time, a channel, an image quality mode, a reference counter, and user information.

The detection unit 10 receives the record presetting information from the record presetting unit 8. When receiving the record presetting information, the detection unit 10 reads record presetting information that has been made by another user from the RAM 7, and compares the record presetting information received from the record presetting unit 8 with the record presetting information read from the RAM 7, so as to judge whether time periods indicated by the two pieces of record presetting information for the same channel overlap each other. When the judgment is affirmative, the detection unit 10 then detects an overlapping time portion and one or more overlapping time portions between the time periods indicated by the two pieces of record presetting information. In addition, the detection unit 10 newly generates record presetting information for each of the overlapping time portion and the non-overlapping time portions, and writes the newly generated record presetting information into the RAM 7. When the judgment is negative, the detection unit 10 writes the record presetting information input from the record presetting unit 8 into the RAM 7 without any changes.

The recording unit 11 performs a recording operation, with reference to the record presetting information newly generated by the detection unit 10 for each of the overlapping and non-overlapping time portions. Then, the recording unit 11 writes video data and management information corresponding to each of the overlapping time portion and the non-overlapping time portions into the DVD drive 1a or the HD drive 1b. According to this construction, the recording unit 11 stores video data for both of the time periods indicated by the pieces of record presetting information into the HD or the DVD, even when the time periods indicated by the pieces of record presetting information overlap each other.

The generation unit 12, as well as the recording unit 11, receives the record presetting information newly generated by the detection unit 10 from the RAM 7. The generation unit 12 generates Cell information based on the record presetting information generated by the detection unit 10. Here, Cell information is logical period information, and only indicates video data corresponding to the time period indicated by each of the record presettings made by the users, out of recorded video data for both of the time periods indicated by the two pieces of record presetting information. As a result, recorded content can be precisely defined in accordance with each of the record presetting. Here, the number of pieces of Cell information indicating video data corresponding to each of the overlapping and non-overlapping time portions is the same as the number shown by a corresponding reference counter included in the management information. Initially, the Cell information does not include user information (0000), which means the open mode. When the closed mode is selected by the users, the generation unit 12 appends user information to the Cell information, so that each of the users has an exclusive access right to the corresponding Cell information. On the other hand, neither of the users owns the video data. Which is to say, each of the users can exclusively own the Cell information, but neither of the users can own the VOB. The multiuser management relating to the first embodiment is achieved in such a manner that each user controls corresponding Cell information.

Thus, a user can perform a playback operation using corresponding Cell information, or delete the corresponding Cell information. When the closed mode is selected by the user, the generation unit 12 appends user information to the corresponding Cell information, with reference to user information included in record presetting information received from the RAM 7. The generation unit 12 then writes the corresponding Cell information into the DVD drive 1a or the HD drive 1b.

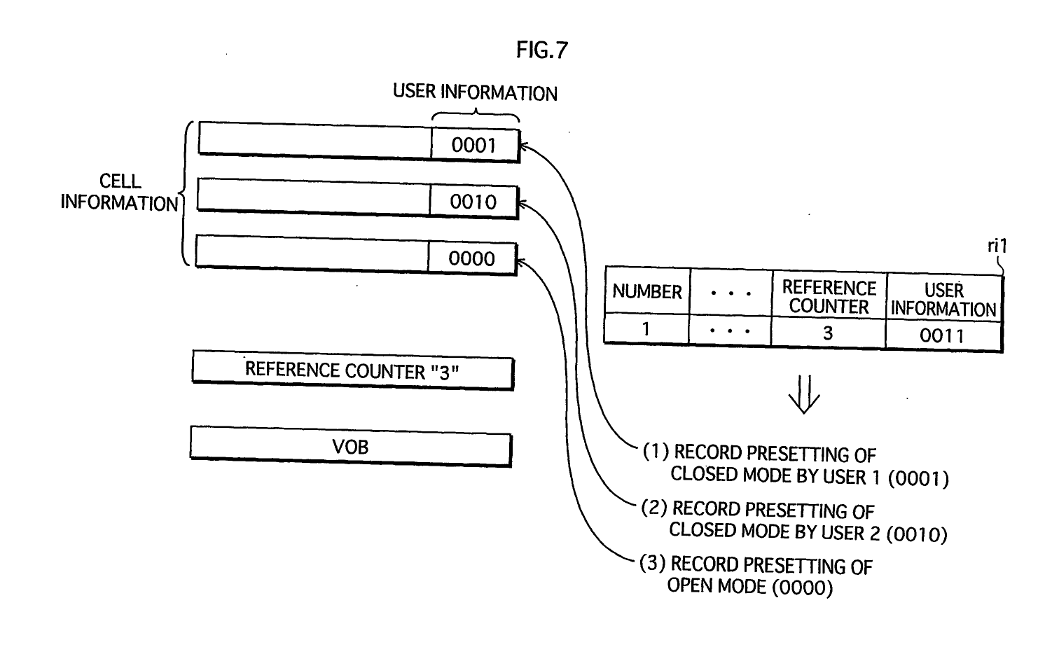

FIG. 7 illustrates, as an example, how the generation unit 12 appends user information to Cell information generated by the generation unit 12, with reference to record presetting information ri1. In the record presetting information ri1 shown in FIG. 7, a reference counter indicates three, and user information indicates 0011. This means that there are three record presettings which include a record presetting of the closed mode made by a user 1 (0001), a record presetting of the closed mode made by a user 2 (0010), and a record presetting of an open mode (0000). FIG. 7 illustrates the generation unit 12 appends the user information to each piece of Cell information, in accordance with the three record presettings.

The authentication unit 13 authenticates whether a user who desires to play back, delete or edit recorded content that is recorded in the closed mode is a user who has an access right to Cell information defining the recorded content.

The execution unit 14 performs a playback operation using Cell information, and deletes and edits Cell information in response to an instruction from a user. In the case of Cell information indicating the closed mode, the execution unit 14 performs the playback, deletion and edition operations after the authentication unit 13 successfully authenticates the user.

The deletion unit 15 deletes a VOB in response to an instruction from the user in the following two steps. In the first step, the execution unit 14 deletes Cell information that corresponds to the VOB and is assigned to the user. This is achieved merely by the user's operation to delete the Cell information. A reference counter for the VOB is decremented by one in accordance with the deletion of the Cell information. After the first step, however, the VOB still exists.

In the second step, the deletion unit 15 deletes the VOB. This makes a space which was occupied by the deleted VOB vacant, thereby increasing an available capacity for storing data in the storage medium. The second step of deleting the VOB is performed only when the reference counter indicates zero. This restriction is defined because the VOB must be maintained unless it is confirmed that no Cell information references the VOB.

The display unit 16 is a circuit to show a data size of recorded content stored in the storage medium. Here, the data size shown by the display unit 16 is larger than an actual total data size of Cell information stored in the storage medium. In this way, users of the recording device provisionally realize the data size of the recorded content on the larger side. According to this, the users realize a remaining capacity of the storage medium on the smaller side, when time periods indicated by record presettings for the same channel made by users overlap each other, and therefore a plurality of pieces of Cell information correspond to a set of video data. This encourages the users to save the capacity of the storage medium, for example, by performing data reduction voluntarily or avoiding recording unnecessary programs. The users can select whether the display unit 16 shows the actual or provisional size of the occupied capacity of the storage medium.

The following part describes a procedure in which the detection unit 10 detects an overlapping time portion and one or more non-overlapping time portions between time periods indicated by record presettings and newly generates record presetting information for each of the overlapping time portion and the non-overlapping time portions, and a procedure to delete recorded video data.

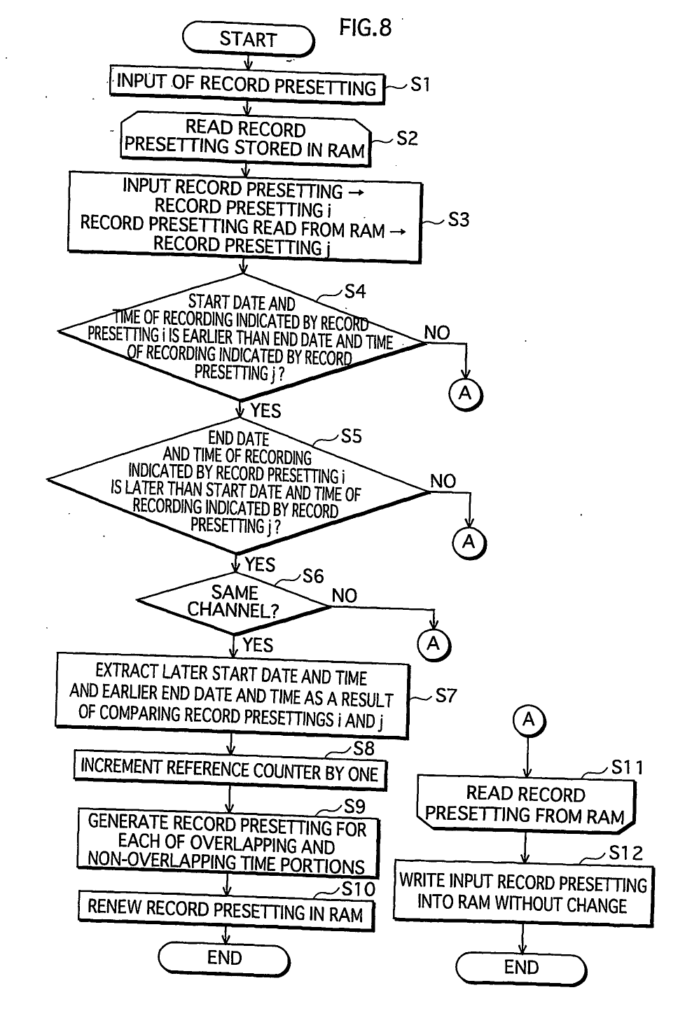

FIG. 8 is a flow chart to describe the procedure in which the detection unit 10 detects an overlapping time portion and one or more non-overlapping time portions between time periods indicated by record presettings, and newly generates record presetting information for each of the overlapping time portion and the non-overlapping time portions.

Firstly, the detection unit 10 receives record presetting information through the menu mn1 shown in FIG. 5 (step S1). The detection unit 10 then reads a piece of record presetting information which comes the first, in terms of input date and time, among pieces of record presetting information stored in the RAM 7 (step S2). Here, the record presetting information currently input through the menu mn1 is called a record presetting i, and the record presetting information read from the RAM 7 is called a record presetting j (step S3). The detection unit 10 compares recording start date and time indicated by the record presetting i with recording end date and time indicated by the record presetting j. Here, the detection unit 10 detects that the recording end date and time indicated by the record presetting j is later (step S4). After this, the detection unit 10 compares recording end date and time indicated by the record presetting i with recording start date and time indicated by the record presetting j. Here, the detection unit 10 detects that the recording end date indicated by the record presetting i is later (step S5). Then, the detection unit 10 compares channels indicated by the record presettings i and j with each other. When the channels are the same, the detection unit 10 judges that the time periods indicated by the record presettings i and j overlap each other (step S6).

When the channels indicated by the record presettings i and j are not the same, the detection unit 10 judges that the time periods indicated by the record presettings i and j do not overlap each other in the first embodiment because this requires a plurality of tuners and MPEG encoders. After this, the detection unit 10 compares the time periods indicated by the record presettings i and j, to extract later recording start date and time and earlier recording end date and time. When the record presettings i and j indicate the same time period, the detection unit 10 extracts the recording start date and time and the recording end date and time of the time period. Based on the result of this extraction, the detection unit 10 defines the overlapping time portion (step S7).

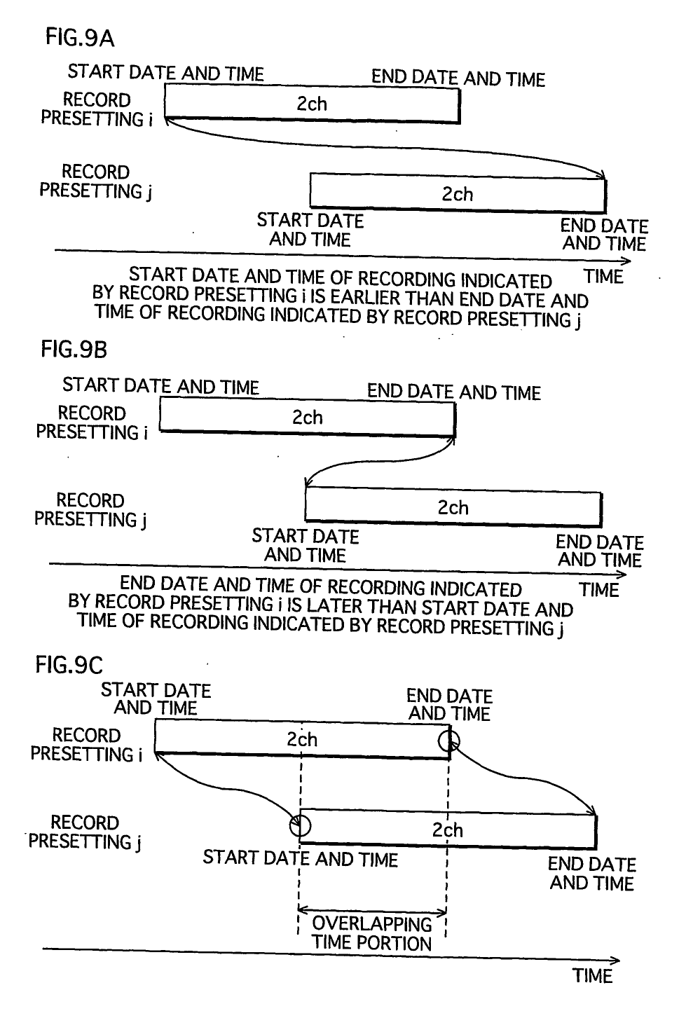

FIG. 9 illustrates the procedure to determine the overlapping time portion as described in the above steps S4 to S7. The following part explains FIG. 9.

Firstly, the detection unit 10 compares the recording start date and time indicated by the record presetting i with the recording end date and time indicated by the record presetting j. As shown in FIG. 9A, the detection unit 10 judges that the recording start date and time indicated by the record presetting i is earlier than the recording end date and time indicated by the record presetting j.

After this, the detection unit 10 compares the recording end date and time indicated by the record presetting i with the recording start date and time indicated by the record presetting j. As shown in FIG. 9B, the detection unit 10 judges that the recording end date and time indicated by the record presetting i is later than the recording start date and time indicated by the record presetting j.

Then, the detection unit 10 judges that the record presettings i and j both indicate the same channel (channel 2). Accordingly, the detection unit 10 judges that the time periods indicated by the record presettings i and j overlap each other.

After this, the detection unit 10 defines the overlapping time portion in the manner shown in FIG. 9C. The detection unit 10 compares the recording start dates and times indicated by the record presettings i and j. Here, the detection unit 10 sets a later date and time as a recording start date and time of the overlapping time portion. In addition, the detection unit 10 compares the recording end dates and times indicated by the record presettings i and j. Here, the detection unit 10 sets an earlier date and time as a recording end date and time of the overlapping time portion. In this way, the detection unit 10 completes the detection of the overlapping time portion. The following part describes the steps after the step S7 in the flow chart shown in FIG. 8.

The detection unit 10 then increments, by one, a reference counter indicating the number of users who desires to record video data corresponding to the overlapping time portion (step S8). Then, the detection unit 10 newly generates record presetting information for each of the overlapping time portion between the time periods indicated by the record presettings i and j and the non-overlapping time portions (step S9). The detection unit 10 then writes the record presetting information newly generated in the step S9 into the RAM 7 (step S10).

When the operation performed in the steps S3 to S6 shows that the time periods indicated by the record presettings i and j do not overlap each other, the detection unit 10 again reads a piece of record presetting information which comes the first in terms of input date and time among the pieces of record presetting information in the RAM 7. Thus, the detection unit 10 repeats the operation described above until the detection unit 10 finds record presetting information which indicates a time period that overlaps the time period indicated by the record presetting i, or reads out all of the pieces of record presetting information from the RAM 7 (step S11). If the detection unit 10 does not find a record presetting which indicates a time period that overlaps the time period indicated by the record presetting i even after reading out all of the pieces of record presetting information from the RAM 7, the detection unit 10 writes the record presetting information input in the step S1 (the record presetting i) into the RAM 7 without any changes (step S12).

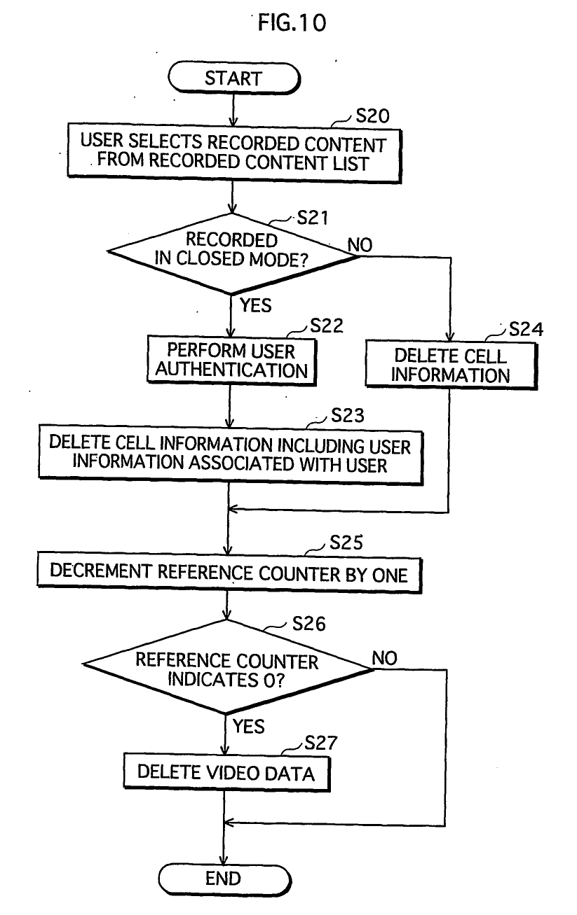

The following part describes the procedure to delete recorded video data, with reference to the flow chart shown in FIG. 10.

A user selects a piece of recorded content s/he desires to delete from a recorded content list (mentioned later) (step S20). When the selected recorded content is recorded in the closed mode, the authentication unit 13 authenticates the user (steps S21 and S22). Then, the execution unit 14 deletes Cell information which indicates the recorded content and includes user information indicating the user (step S23). When the selected recorded content is recorded in the open mode, the execution unit 14 deletes Cell information which indicates the recorded content and does not include user information (step S24).

After this, a reference counter which indicates the number of users who have the selected recorded content recorded is decremented by one (step S25).

When the reference counter indicates zero (step S26), the deletion unit 15 deletes video data corresponding to the selected recorded content (step S27).

(Record Presetting)

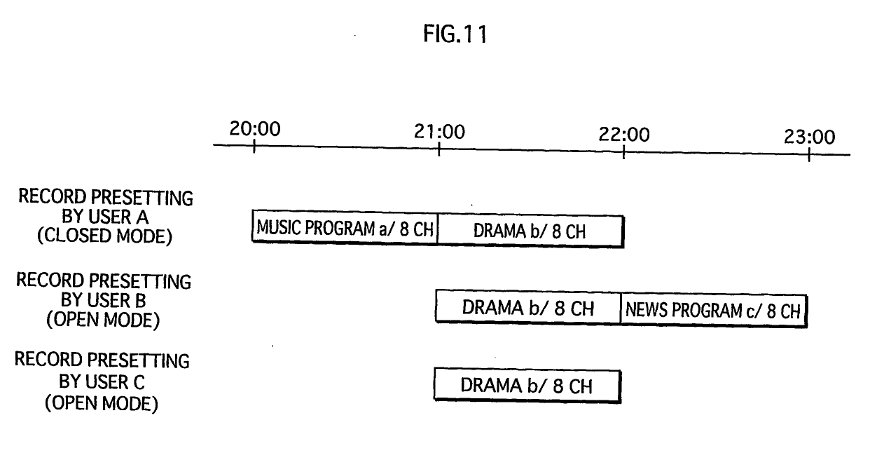

The following part describes an operation of the recording device relating to the first embodiment of the present invention, with use of a concrete example shown in FIG. 11. Specifically speaking, a user A makes a record presetting of the closed mode for a music program a and a drama b, a user B makes a record presetting of the open mode for the drama b and a news program c, and a user C makes a record presetting of the open mode for the drama b. As shown in FIG. 11, the time periods indicated the record presettings for the same channel made by the three users A, B and C overlap each other and the overlapping time portion is from 21:00 to 22:00 during which the drama b is broadcasted.

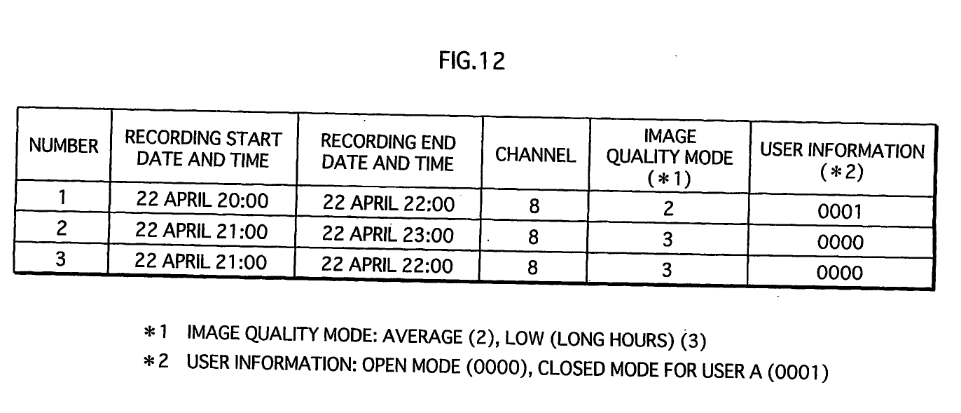

FIG. 12 illustrates record presetting information input by each of the three users A, B and C through the menu mn1 shown in FIG. 5.

To make a record presetting of the closed mode, a user first inputs, to the record presetting menu mn1 shown in FIG. 5, appropriate numerals to set the recording start date and time, the recording end date and time, and the channel, and selects a desired image quality to set the image quality mode.

When the user selects the closed mode in setting the user mode, a pop-up menu such as the user registration menu mn2 shown in FIG. 5 appears. The user inputs a user's name and a password to the menu mn2. Thus, the user can make the record presetting of the closed mode. Also, information unique to the user is appended to Cell information specifying video data corresponding to a time period indicated by the record presetting of the closed mode made by the user.

To make a record presetting of the open mode, the user selects the open mode in setting the user mode on the record presetting menu mn1.

When the user has made the record presetting, the detection unit 10 judges whether the time period indicated by the record presetting overlap a time period indicated by record presetting information read from the RAM 7. When the judgment is affirmative, the detection unit 10 newly generates a plurality of pieces of record presetting information for the overlapping time portion and one or more non-overlapping time portions, in one-to-one correspondence, and writes the pieces of record presetting information into the RAM 7.

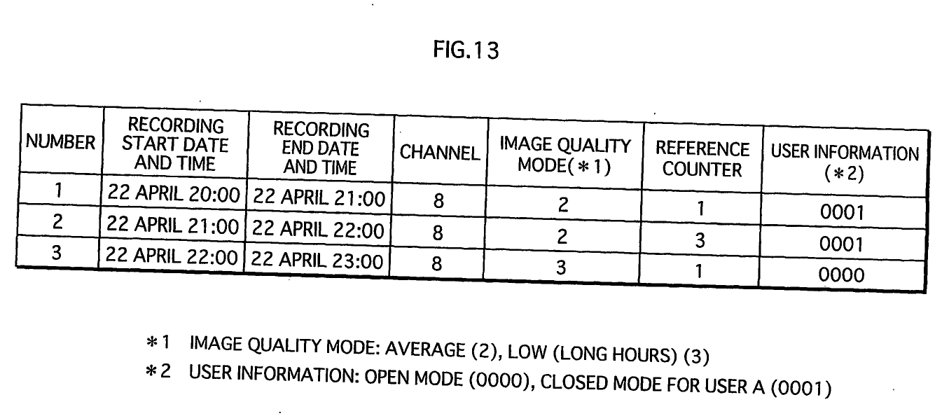

FIG. 13 illustrates, as an example, a plurality of pieces of record presetting information that are generated by the detection unit 10, in one-to-one correspondence, for the overlapping time portion and one or more non-overlapping time portions among the recording presettings made by the users A, B and C and then written into the RAM 7. In FIG. 12, the record presetting made by the user A indicates one continuous time period from 20:00 to 22:00. According to the pieces of record presetting information shown in FIG. 13, however, there are two pieces of record presetting information for the time period from 20:00 to 22:00, i.e. for the two time periods of 20:00 to 21:00 and 21:00 to 22:00. This is because the time periods indicated by the three users A, B and C have the overlapping time portion of 21:00 to 22:00. The detection unit 10 therefore newly generates record presetting information for the overlapping time portion of 21:00 to 22:00 and record presetting information for a non-overlapping time portion of 20:00 to 21:00.

The record presetting information for the overlapping time portion of 21:00 to 22:00 (information 2) has a reference counter indicating three. This is because the three users requests recording of video data for the overlapping time portion.

The record presetting information for the overlapping time portion of 21:00 to 22:00 has user information showing “0001”. This means the user A selects the closed mode.

As shown in FIG. 12, the user A selects “average” (2), but the users B and C select “low (long hours)” (3) for the image quality mode. Which is to say, two different image quality options are selected for the overlapping time portion. If such is the case, an option for a higher image quality is selected.

Accordingly, the “average” option is selected for the image quality mode for the overlapping time portion.

The following part describes a recording operation by the recording device relating to the first embodiment. The recording unit 11 and the generation unit 12 perform the recording operation for each of the overlapping time portion and the non-overlapping time portions, based on the pieces of record presetting information stored in the RAM 7 as shown in FIG. 13.

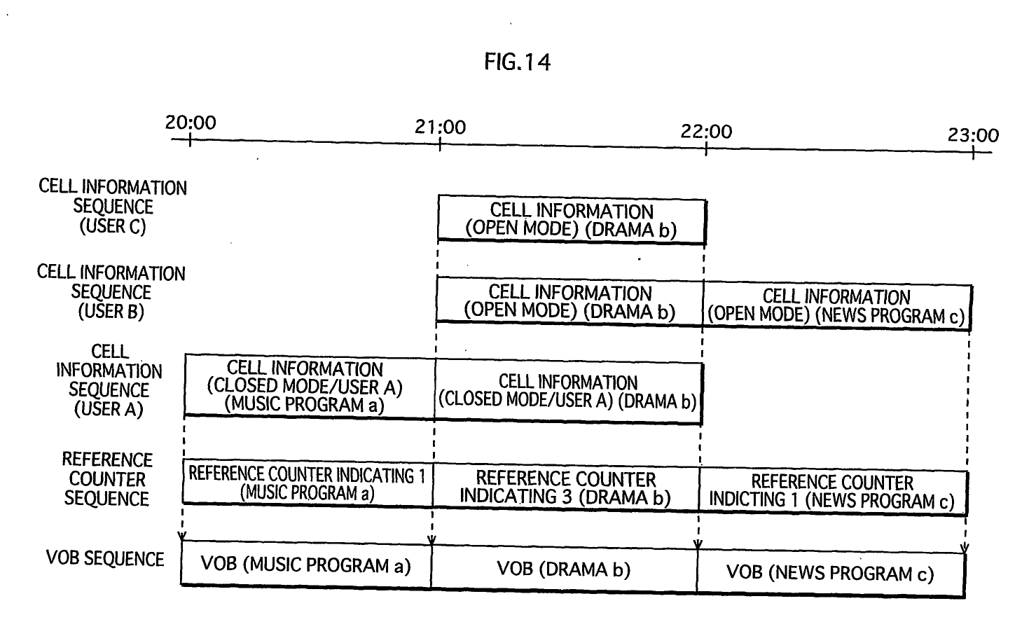

FIG. 14 illustrates the result of the recording operation. FIG. 14 illustrates pieces of recorded content which respectively correspond to three different time periods, that is to say, the overlapping and non-overlapping time portions, using the VOB sequence, the reference counter sequence, and Cell information sequences. FIG. 14 is used to describe the recording operation.

Firstly, an operation for the record presetting information 1 (shown in FIG. 13) is performed. The recording unit 11 generates a VOB, which is video data, and management information including a reference counter, and then writes the VOB and management information into the DVD drive 1a or the HD drive 1b. It is only the record presetting of the closed mode made by the user A which indicates the music program a. Accordingly, the reference counter for the music program a indicates one. Here, the generation unit 12 generates a piece of Cell information indicating the time period of 20:00 to 21:00 which does not include user information. After appending user information to the piece of Cell information so as to mean that the user A makes the record presetting of the closed mode for the music program a, the generation unit 12 writes the piece of Cell information into the DVD drive 1a or the HD drive 1b.

After this, an operation for the record presetting information 2 (shown in FIG. 13) is performed. The two users B and C selects an open mode, and the user A selects a closed mode, for the time period indicated by the record presetting information 2. The recording unit 11 generates a VOB and management information including a reference counter, and then writes the VOB and management information into the DVD drive 1a or the HD drive 1b. Since the reference counter indicates three, the generating unit 12 generates three pieces of Cell information indicating the time period of from 21:00 to 22:00 which does not include user information. After appending user information to one of the three pieces of Cell information so as to mean that the user A makes the record presetting of the closed mode for the drama b, the generation unit 12 writes the three pieces of Cell information into the DVD drive 1a or the HD drive 1b.

Lastly, an operation for the record presetting information 3 (shown in FIG. 13) performed. Only the user B makes the record presetting of the open mode for the time period indicated by the record presetting information 3. The recording unit 11 generates a VOB and management information including a reference counter, and then writes the VOB and management information into the DVD drive 1a or the HD drive 1b. Since the reference counter indicates one, the generating unit 12 generates a piece of Cell information indicating the time period of from 22:00 to 23:00 which does not include user information. The generation unit 12 writes the piece of Cell information into the DVD drive 1a and the HD drive 1b.

(Data Deletion)

The following part describes a method to delete recorded content recorded in the above-described manner by the recording device relating to the first embodiment of the present invention, with use of a concrete example.

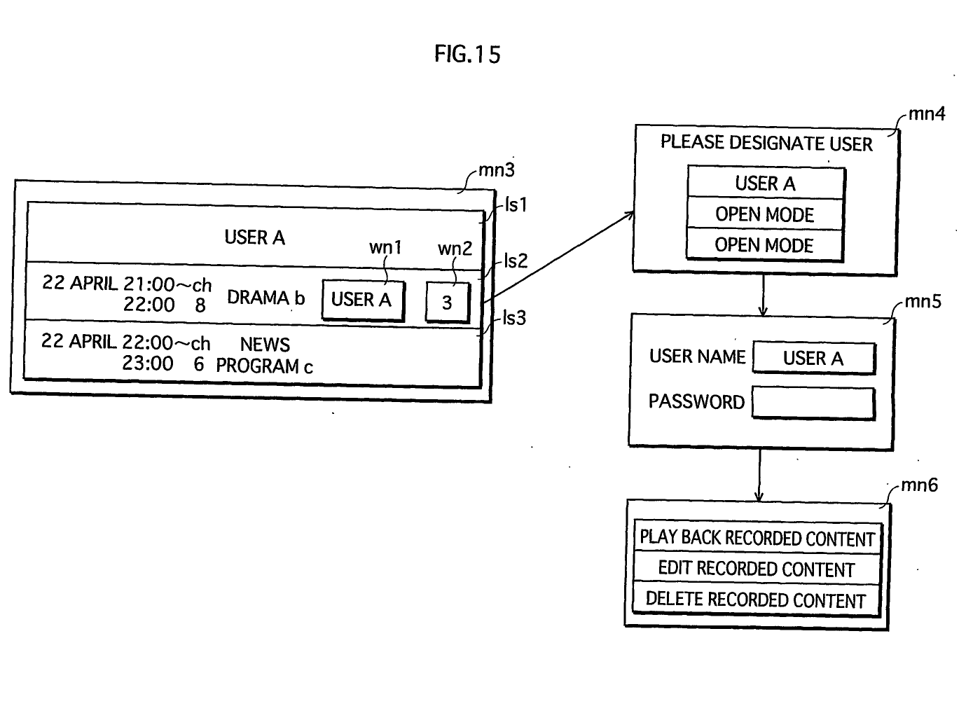

FIG. 15 illustrates a recorded content list mn3 which is a menu displaying a plurality of pieces of recorded content stored in the DVD drive 1a or the HD drive 1b. The user easily plays back and deletes a piece of recorded content by selecting the piece of recorded content on the menu.

The recorded content list mn3 shows pieces of recorded content corresponding to the three time periods, which respectively indicate the music program a (an item ls1), the drama b (an item ls2), and the news program c (an item ls3) based on the recording result shown in FIG. 14.

The piece of recorded content indicating the music program a is recorded only in the closed mode, and therefore the item ls1 for the music program a shows only the user's name. on the other hand, the items ls2 and ls3 for the other pieces of recorded contents additionally show the date and time of recording, a channel number and the like. This has a purpose of protecting the privacy of the user A who has the music program a recorded in the closed mode, by keeping it a secret to the other users which program the user A has recorded.

The item ls2 for the drama b includes the user information wn1 showing USER A and the reference counter wn2 indicating three, in addition to the date and time of recording and the channel number. A reference counter is shown only when indicating two or more which means a plurality of users has a corresponding piece of recorded content recorded.

The item ls3 for the news program c does not show the reference counter for the reason stated above. Which is to say, the reference counter for the new program c indicates one.

When the user selects the item ls2 for the drama b, a user designation menu mn4 pops up to identify which of the three users who has the drama b recorded is to perform an operation on the piece of recorded content.

When the user selects the user A through the user designation menu mn4, a user authentication menu mn5 next pops up.

The user inputs a password corresponding to the user A through the user authentication menu mn5, so that the authentication unit 13 authenticates the user.

If the authentication unit 13 successfully authenticates the user, a recorded content execution menu mn6 pops up.

When the user selects DELETE RECORDED CONTENT through the recorded content execution menu mn6, the execution unit 14 deletes a piece of Cell information which indicates the drama b and includes the user information indicating the user A. As a result of the deletion, the reference counter wn2 shown in FIG. 15 is decremented by one.

According to the first embodiment described above, when time periods indicated by record presettings for the same channel made by a plurality of users overlap each other, the detection unit 10 detects an overlapping time portion and one or more non-overlapping time portions between the time periods indicated by the record presettings, and newly generates record presetting information for each of the overlapping time portion and the non-overlapping time portions. The recording unit 11 performs a recording operation by generating video data and management information for each of the overlapping time portion and the non-overlapping time portions, with reference to the newly generated record presetting information. The generation unit 12 generates Cell information indicating the time period indicated by each piece of newly generated record presetting information. Here, if any of the users selects the closed mode, the generation unit 12 appends user information unique to the user to corresponding Cell information so as to mean the closed mode.

Thus, each of the users can play back desired recorded content by manipulating Cell information assigned to him/her.

When one of the users desires to delete a piece of recorded content corresponding to the overlapping time portion after watching the recorded content, this only deletes Cell information which is period information specifying video data corresponding to the overlapping time portion. The video data itself is not deleted unless the reference counter indicating the number of users who has the video data recorded indicates zero.

Thus, the rest of the users who have the video data corresponding to the overlapping time portion recorded can still watch the video data.

### Second Embodiment

According to the first embodiment, a VOB is deleted from the RD only when a reference counter for the VOB indicates zero as a result of deletion operations performed by all users who have the VOB recorded. According to a second embodiment, this restriction on the deletion of the VOB is relaxed. Specifically speaking, any user is allowed to delete the VOB when the reference counter for the VOB indicates one or less, and a backup copy of the VOB stored in the HD has been created on the DVD.

This relaxation of the restriction is made taking into consideration that one of the users who have the VOB recorded on the HD does not watch the VOB for a long time. If such is the case, according to the first embodiment, the VOB can not be deleted and therefore occupies a space of the HD for a long time. This may make it impossible to record more VOBs due to a shortage of a free space in the HD. According to the second embodiment, however, the VOB is deleted from the HD and stored in the DVD.

When the reference counter for the VOB indicates two or more, it is not allowed to delete the VOB even when the backup copy of the VOB has been created on the DVD. The reason for this is explained in the following. When the reference counter indicates two or more, the VOB stored in the HD is referenced by two or more pieces of Cell information. If the VOB is deleted from the HD, the VOB can not be played back based on one or more pieces of Cell information which are assigned to one or more users that are not the one who does not watch the VOB for a long time.

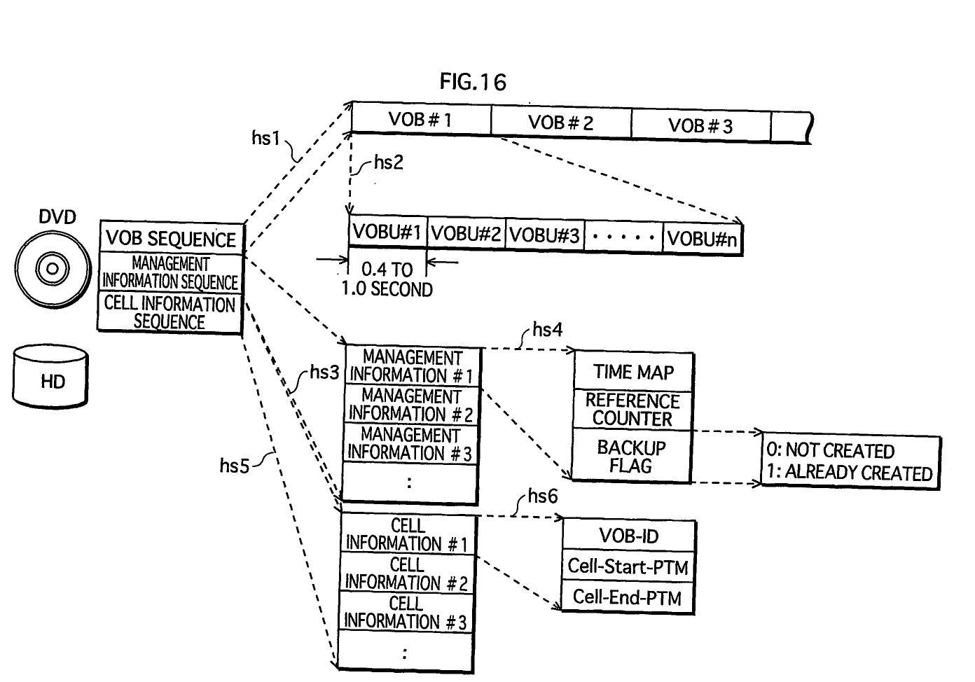

FIG. 16 illustrates a construction of management information to perform the deletion operation relating to the second embodiment. As shown in FIG. 16, management information for a VOB additionally includes a backup flag. When the backup flag is set to zero, it is indicated that a backup copy of the VOB has not been created yet. When the backup flag is set to one, it is indicated that the backup copy of the VOB has been created.

The deletion unit 15 and the authentication unit 13 are modified to achieve the deletion operation relating to the second embodiment.

When deleting the VOB stored in the HD in accordance with a user operation, the deletion unit 15 judges whether the backup copy of the VOB has been created and whether the reference counter for the VOB indicates one, with reference to the management information for the VOB. When the backup copy of the VOB has been created and the reference counter indicates one, the deletion unit 15 deletes the VOB stored in the HD without requiring user authentication through an input of a password.

The authentication unit 13 receives an input of a password from a user who desires to play back the backup copy created on the DVD. The authentication unit 13 permits the execution unit 14 to play back the recorded content only when the authentication unit 13 successfully authenticates an access right of the user.

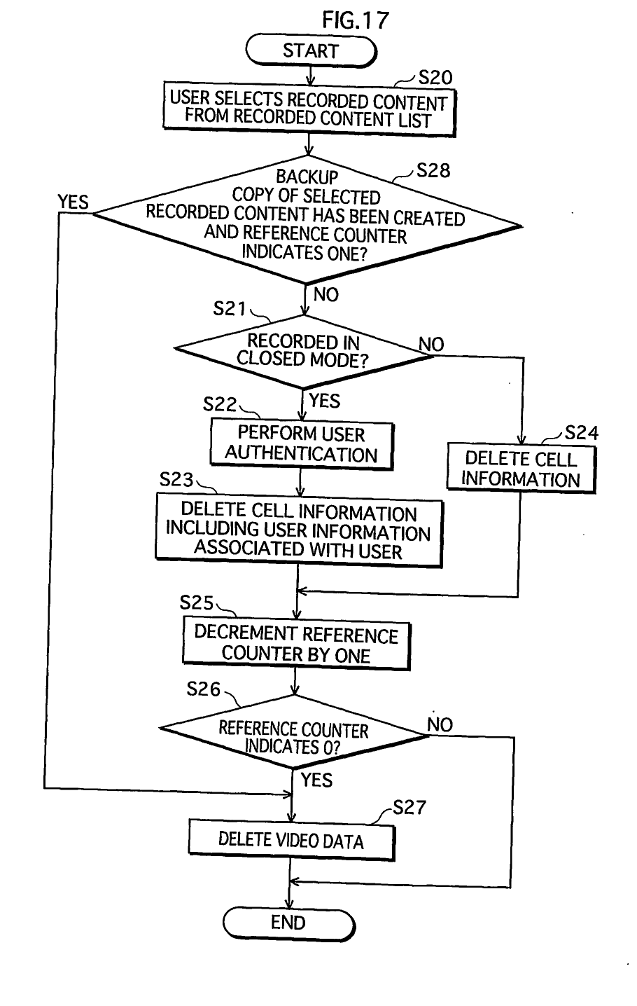

FIG. 17 is a flow chart illustrating a procedure performed by the deletion unit 15 relating to the second embodiment. The flowchart in FIG. 17 is based on the one shown in FIG. 10 described in the first embodiment, but different in terms of the step S28 between the steps S20 and S21. The following part describes the procedure performed by the deletion unit 15 relating to the second embodiment, with reference to the flow chart shown in FIG. 17.

When a user selects recorded content to be deleted in the step S20, the new step S28 is performed.

In the step S28, the deletion unit 15 judges whether a backup copy of the selected recorded content has been created and whether a reference counter for the recorded content indicates one or less, with reference to management information for a VOB corresponding to the recorded content. If the both judgments are affirmative, the step S27 is next performed. Which is to say, the deletion unit 15 deletes the VOB in the HD without requiring user authentication through an input of a password.

When the reference counter indicates two or more, or when the reference counter indicates one or less but the backup copy of the recorded content has not been created in the step S28, the steps S21 to S27 are performed as in the first embodiment. In detail, when the recorded content is recorded in the closed mode (step S21:YES), user authentication is performed through an input of a password (step S22), to delete a corresponding piece of Cell information (step S23). Then, the reference counter for the recorded content is decremented by one (step S25). If the reference counter indicates zero, the video data is deleted (step S27).

According to the second embodiment, any user can delete a VOB stored on the HD, if the conditions are satisfied. Thus, even when one of the users who have the VOB recorded does not watch the VOB for a long time, a decent free space in the HD can be secured. This contributes to prevent troubles among users who share the recording device, thereby making it possible for the users to share the recording device without problems.

(Modifications)

The present invention is described in the above part with reference to the embodiments. However, the present invention is not limited to the embodiments, and the recording devices relating to the embodiments can be partly further modified.

(A) According to the first embodiment, the detection unit 10 detects an overlapping time portion regarding record presettings which each specify recording start date and time, recording end date and time and a channel number. However, the detection unit 10 may detect an overlapping time portion regarding record presettings which each specify programs using broadcast guide information, that is to say, the EPG and G-codes.

(B) In the first embodiment, Cell information of a HD or a DVD is taken as an example of period information specifying video data which includes user information unique to a user. The storage medium is not limited to a HD or DVD. Any storage medium can be used as long as it defines period information to which user information can be appended.

(C) The first embodiment describes a deletion operation which deletes a whole of recorded content. However, a user who has recorded content recorded in the closed mode can also perform a partial deletion operation which keeps a favorite part of the recorded content, and deletes a part that is no longer necessary. The partial deletion operation is performed in such a manner that the user deletes Cell information which specifies the recorded content and includes user information indicating the user, similarly to the whole deletion operation, not in such a manner that the user deletes video data corresponding to the recorded content. The following part describes the partial deletion operation.

Firstly, the user determines a range to keep by defining In- and Out-points of a playback time period in the recorded content on which the partial deletion operation is to be performed.

Next, VOB-ID, Cell_Start_PTM, and Cell_End_PTM included in the Cell information for the video data corresponding to the recorded content are renewed based on the In- and Out-points newly defined by the user. Thus, the renewed Cell information only indicates the range the user desires to keep.

According to this partial deletion operation, it is not the video data which is partly deleted. Thus, the user can perform the partial deletion operation to watch only the desired range without causing any problems to other users.

Here, the user who has the recorded content recorded in the closed mode may also be able to have the recorded content played back. The user may select one of the whole deletion operation, the partial deletion operation, and the playback operation through a property provided for the recorded content.

(D) The embodiments describe a recording operation performed when time periods indicated by record presettings for the same channel overlap each other. However, the overlapping time portion may indicate a plurality of logical channels superposed on the same physical channel. Here, the physical channel is, for example, defined by a frequency range, and the logical channel is obtained by time-division multiplexing.

(E) The recording devices relating to the embodiments may be connected to televisions, or integrated into liquid crystal displays. A HD drive, a DVD drive, and an MPEG encoder are included in the recording devices, but may be connected to the recording devices via a connector of IEEE1394. Furthermore, the recording devices may only include the CPU and the ROM, i.e. the essential constituents for processing.

These modified recording devices are also included in the present invention. Manufacturing of a recording device based on the inner structure of the recording devices relating to the embodiments and the modifications is considered to be exploitation of the present invention disclosed in the description. Here, the exploitation of the present invention includes acts of assigning, leasing and importing the recording devices relating to the embodiments and the modifications for free (donation) or profit (sales), and acts of offering assignment or lease of the recording devices to public users by advertising them in the shopwindow and through distribution of pamphlets and catalogues.

(F) Information processing executed by a program which is described in FIGS. 8, 10 and 17 is achieved with physical use of hardware resources such as the CPU 6, the RAM 7 and the

DVD drive 1a. Accordingly, the program itself is considered an invention. The embodiments describe exploitation of the program, which is an embodiment of the present invention, in a state of being stored in the recording devices. However, the program may be separated from the recording devices. The exploitation of the program includes acts of (i) producing the program, (ii) assigning the program for free or profit, (iii) leasing the program, (iv) importing the program, (v) providing the program for the public via two-way electronic communication lines and (vi) offering assignment or lease of the program to public users by advertising the program in the shopwindow and through distribution of pamphlets and catalogues.

Typical examples of the act of providing the program via two-way electronic communication lines (v) are the program download service, whereby a provider transmits the program to users so as that the users can use the program, and the application service provider (ASP) service, whereby the functions of the program are provided for the users via electronic communication lines but the program itself is kept by the provider.

(G) The temporal order of the procedure, i.e. the order of the steps in each of the flow charts in FIGS. 8, 10 and 17, is considered to be a fundamental matter to specify the invention. The procedure shown in each of the above flow charts achieves the object of the present invention relating to multiuser management in a recording device, for example, a recording operation for an overlapping time portion, and deletion of recorded content. Which is to say, the flow charts show embodiments of a recording control method, which is an embodiment of the present invention. If the steps in each flow chart are executed in the described temporal order so as to achieve the original object and effects of the present invention, the procedures in these flow charts are undoubtedly embodiments of the recording control method which is an embodiment of the present invention.

(H) In the embodiments, video data is a VOB, which is obtained by encoding an analog image signal used in an analog broadcast. However, the video data may be stream data made up by a transport stream used in a digital broadcast.

Alternatively, the video data may be obtained by encoding an analog/digital image signal recorded in a video tape, or by encoding an analog/digital image signal retrieved directly through a camcorder. Furthermore, the video data may be digital works, for example, a film which is distributed in a state of being stored in a storage medium, or digital works distributed by a distribution server.

(I) According to the embodiments, a time period indicated by a record presetting, an overlapping time portion, and other time periods or portions are expressed using a combination of a playback start point (Cell_Start_PTM) and a playback end point (Cell_End_PTM) included in Cell information. However, this is based on the DVD-Video Recording standard and only serves as an example. As an alternative, the time periods and portions may be expressed using a combination of a playback start point (Start_PTM) and a length. Furthermore, the playback start and end points may not be time information, but logical addresses on a storage medium.

### INDUSTRIAL APPLICABILITY

The present invention realizes multiuser management on a recording device. Therefore, the present invention heightens a commercial value of HD recorders and the like, thereby providing attractive products. As a consequence, the present invention is highly applicable to household products.

1. A recording device that performs a recording operation based on a plurality of record presettings made by a plurality of users, comprising:
a detection unit operable to, if time periods indicated by the plurality of record presettings have an overlapping time portion, detect the overlapping time portion and a non-overlapping time portion;
a writing unit operable to write video data for the overlapping time portion and video data for the non-overlapping time portion, onto a storage medium; and
a generation unit operable to generate, on the storage medium, period information that expresses each of the time periods indicated by the plurality of record presettings, the period information specifying video data for one or more time portions which form the corresponding time period.

2. The recording device of claim 1, wherein
when generating the period information, the generation unit appends user information to the period information,
the user information (i) identifying which user makes a record presetting indicating the time period expressed by the period information and (ii) indicating that only the identified user is allowed to perform an operation on the video data specified by the period information.

3. The recording device of claim 1, wherein
each record presetting is of a closed mode or an open mode,
when a record presetting of the closed mode is made, the generation unit appends user information to period information that expresses a time period indicated by the record presetting of the closed mode,
the user information (i) identifying which user makes the record presetting of the closed mode and (ii) indicating that only the identified user is allowed to perform an operation on video data specified by the period information, and
when a record presetting of the open mode is made, the generation unit appends default information to period information that expresses a time period indicated by the record presetting of the open mode,
the default information indicating that any user is allowed to perform an operation on video data specified by the period information.

4. The recording device of claim 3, further comprising:
an authentication unit operable to, when a user requests a playback operation based on the period information for the record presetting of the closed mode, receive user information unique to the user who requests the playback operation, and authenticate the user by comparing the received user information with the user information appended to the period information; and
an execution unit operable to execute the playback operation only when the authentication unit successfully authenticates the user.

5. The recording device of claim 3, further comprising:
an authentication unit operable to, when a user requests a deletion or edition operation on the period information for the record presetting of the closed mode, receive user information unique to the user who requests the deletion or edition operation, and authenticate the user by comparing the received user information with the user information appended to the period information; and
an execution unit operable to execute the deletion or edition operation only when the authentication unit successfully authenticates the user.

6. The recording device of claim 5, wherein
the writing unit writes, onto the storage medium, a reference counter for the video data for the overlapping time portion, the reference counter showing a number of pieces of period information that reference the video data.

7. The recording device of claim 6, further comprising:
a deletion unit operable to delete the video data for the overlapping time portion only when the reference counter indicates zero, wherein
the reference counter is decremented by one, every time a piece of period information referencing the video data for the overlapping time portion is deleted.

8. The recording device of claim 1, wherein
the plurality of record presettings are made based on broadcast guide information, and
each of the overlapping time portion and the non-overlapping time portion is a time period during which a program shown in the broadcast guide information is broadcasted.

9. The recording device of claim 1, further comprising:
a display unit operable to display a provisional available capacity of the storage medium, the provisional available capacity being calculated by subtracting a predetermined value from a maximum capacity of the storage medium, the predetermined value being determined in accordance with a number of pieces of period information that reference the video data for each of the overlapping and non-overlapping time portions.

10. The recording device of claim 1, wherein
when recording end date and time indicated by one of the plurality of record presettings is later than recording start date and time indicated by at least one of a rest of the plurality of record presettings, the detection unit judges that the time periods indicated by the plurality of record presettings made by the plurality of users have the overlapping time portion.

11. The recording device of claim 1, further comprising:
a judging unit operable to judge, when a user requests deletion of video data, whether a backup copy of the video data requested to be deleted has been created; and
a deletion unit operable to delete the video data, when the judging unit judges that the backup copy of the video data requested to be deleted has been created.

12. The recording device of claim 11, wherein
when writing the period information into the storage medium, the generation unit appends user information to the period information, and
the recording device further comprises:
an authentication unit operable to, when the judging unit judges that the backup copy of the video data requested to be deleted has not been created, receive user information unique to the user who requests the deletion, and authenticate the user by comparing the received user information with user information appended to period information specifying the video data requested to be deleted.

13. The recording device of claim 12, wherein
the storage medium includes an internal storage medium and a portable storage medium, and
the video data requested to be deleted is originally stored in the internal storage medium and the backup copy is created in the portable storage medium.

14. The recording device of claim 13, wherein
when a user requests playback of the backup copy created in the portable storage medium, the authentication unit authenticates the user who requests the playback.

15. The recording device of claim 13, wherein
the internal storage medium stores a reference counter for the video data requested to be deleted, the reference counter showing a number of pieces of period information that reference the video data requested to be deleted,
only when the judging unit judges that the backup copy of the video data requested to be deleted has been created, and the reference counter indicates one or less, the deletion unit deletes the video data requested to be deleted from the internal storage medium.

16. The recording device of claim 15, wherein
the reference counter is decremented by one, every time a piece of period information referencing the video data requested to be deleted is deleted.

17. A computer-readable program to have a computer perform a recording operation based on a plurality of record presettings made by a plurality of users, the computer-readable program comprising:
a detection step of, if time periods indicated by the plurality of record presettings have an overlapping time portion, detecting the overlapping time portion and a non-overlapping time portion;
a writing step of writing video data for the overlapping time portion and video data for the non-overlapping time portion, onto a storage medium; and
a generation step of generating, on the storage medium, period information that expresses each of the time periods indicated by the plurality of record presettings, the period information specifying video data for one or more time portions which form the corresponding time period.

18. An integrated circuit for use in a recording device to perform a recording operation based on a plurality of record presettings made by a plurality of users, the integrated circuit comprising:
a detection unit operable to, if time periods indicated by the plurality of record presettings have an overlapping time portion, detect the overlapping time portion and a non-overlapping time portion;
a writing unit operable to write video data for the overlapping time portion and video data for the non-overlapping time portion, onto a storage medium; and
a generation unit operable to generate, on the storage medium, period information that expresses each of the time periods indicated by the plurality of record presettings, the period information specifying video data for one or more time portions which form the corresponding time period.
